(19) United States
(12) Patent Application Publication
(10) Pub. No.: US 2010/0064428 A1
(43) Pub. Date: Mar. 18, 2010

(54) WATER RECREATIONAL APPARATUS WITH CONTROL PANEL HAVING CONTROL BUTTONS WITH AUDIBLE SIGNALS

(76) Inventors: Casey Loyd, Pomona, CA (US); Pedro Vargas, Pomona, CA (US)

Correspondence Address: SHELDON MAK ROSE & ANDERSON PC, 100 Corson Street, Third Floor, PASADENA, CA, 91103-3842, US

(21) Appl. No.: 12/210,414

(22) Filed: Sep. 15, 2008

(51) Int. Cl. A61H 33/00

(52) U.S. Cl. 4/541.3

(57) ABSTRACT

A water recreational apparatus, such as a portable spa, hot tub, above-ground pool or water recirculating bathtub has (a) a water recirculation system, including a water pump and a water heater, (b) a control panel having a plurality of control buttons for controlling the operation of the water pump or water heater, and (c) an audio circuit having a speaker and being adapted to emit an audible signal in response to the engagement of a control button.

### FIELD OF THE INVENTION

This invention relates generally to water recreational apparatuses such as portable spas and hot tubs and, more particularly, to water recreational devices having built-in control panels.

### BACKGROUND

Water recreational apparatuses, such as portable spas, hot tubs, above-ground pools and water recirculating bathtubs have become very popular.

Many such water recreational apparatuses have control panels disposed proximate to the exterior of the water recreational apparatus. These control panels typically comprise control buttons for increasing or decreasing the speed of a recirculating pump, increasing or decreasing the flow of air to the water basin and/or increasing or decreasing the temperature of the water being recirculated back to the water basin. Because such control panels are typically disposed proximate to water within the apparatus, the control panels are usually covered with a water impervious film.

A first problem associated with such control panels arises because of the water impervious film covering the control buttons. Because of this film, it is not easy for the user to perceive when a control button is engaged or disengaged.

Another problem with the use of such control panels is that the visual display of such control panels is difficult to see in bright light, such as in sunlight.

Yet another problem associated with such control panels arises from the fact that the control panels are typically disposed proximate to the exterior of the water recreational apparatus. This makes it convenient for a prospective bather outside the apparatus to initially set the various control parameters, but it means that bathers within the water basin are somewhat distant from the control panel and find it difficult to read the display on the control panel while within the water basin. Moreover, while in the water basin, the control panel must typically be viewed upside down for bathers within the water basin.

A still further problem with such control panels is that they are unuseable for blind people.

Thus, there is a need for water recreational apparatus which avoids the above-described problems in the prior art.

### SUMMARY

The inventions satisfies this need. The invention is a water recreational apparatus comprising (a) a water recirculation system having a water pump and a water heater; (b) a control panel having a plurality of control buttons, the control buttons being operatively adapted such that the engagement of a control button controls the operation of the water pump or the water heater; and (c) an audio circuit having a speaker and being operatively adapted to emit an audible signal in response to the engagement of a control button.

### DRAWINGS

These and other features, aspects and advantages of the present invention will become better understood with reference to the following description, appended claims and accompanying drawings where:

FIG. 1 is a diagrammatic view of a typical water recreational apparatus to which the invention can effectively be applied;

FIG. 2 is a perspective view of a water recreational apparatus having features of the invention;

FIG. 3 is a perspective view of a control panel useable in the invention; and

FIG. 4 is a diagrammatic perspective view of the control panel illustrated in FIG. 3 showing its electrical and electronic connections within the water recreational apparatus.

### DETAILED DESCRIPTION

The following discussion describes in detail one embodiment of the invention and several variations of that embodiment. This discussion should not be construed, however, as limiting the invention to those particular embodiments. Practitioners skilled in the art will recognize numerous other embodiments as well.

The invention is a water recreational apparatus 10 comprising a water recirculation system 12, a control panel 14 and an audio circuit 16 having a speaker 18.

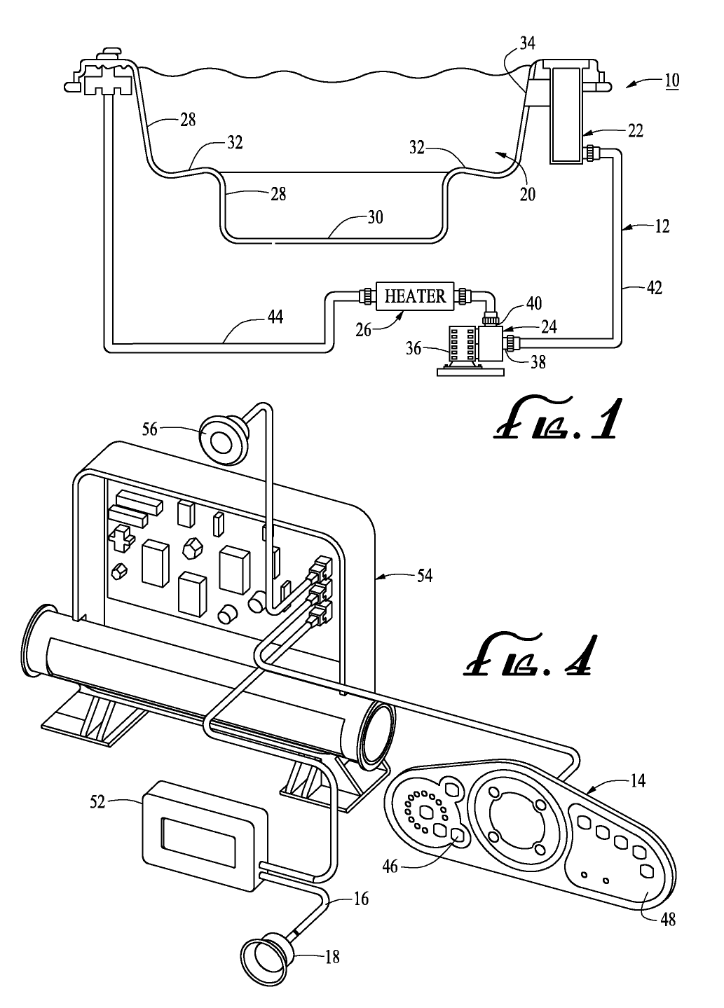

FIG. 1 illustrates a typical water recreational apparatus 10, such as a portable spa, hot tub, above-ground pool or water recirculating bath tub. The water recreational apparatus 10 comprises a water basin 20, a filter 22, a pump 24 and an in-line water heater 26.

The water basin 20 typically has a plurality of generally vertical side walls 28 and a generally horizontal bottom wall 30. The water basin 20 also typically comprises one or more user seat locations 32 and a plurality of recreational jets (not shown) disposed in the upper portion of the side walls. The recreational jets provide an inlet stream of pressurized and aerated water to massage, amuse and otherwise impact the upper torsos of users disposed at the user's seat locations. The recreational jets are disposed so as to project pressurized and aerated water in a generally horizontal direction within the water basin 20.

The water basin 20 typically comprises at least one filter opening 34 for allowing a slip stream of water to flow from the water basin 20 and into the filter 22, the filter 22 typically being disposed external of the water basin 20. In the embodiment illustrated in FIG. 1, the filter opening 34 is disposed in the upper portion of the side walls of the water basin 20.

The pump 24 is typically a centrifugal pump 24 driven by an electric motor 36. The pump 24 has a suction side 38 and a discharge side 40. The suction side 38 of the pump is disposed in fluid tight communication with the filter 22 via a suction line 42. The discharge side 40 of the pump 24 is connected via a discharge line 44 to the recreational jets in the upper portion of the side walls. In a typical water recreational apparatus 10, the speed of the pump 24 can be adjusted between low pump speeds and high pump speeds by adjusting the electric motor 36.

The heater 26 typically is an in-line heater capable of heating recirculating water from ambient temperature to an increased temperature. In typical water recreational apparatuses 10, the heater 26 is adjustable to allow the alternative heating of recirculating water between low increases in temperature and high increases in temperature.

FIG. 2 illustrates a typical water recreation apparatus 10 of the invention having the control panel 14 disposed proximate to the exterior of the water recreational apparatus 10 and facing away from the water basin 20.

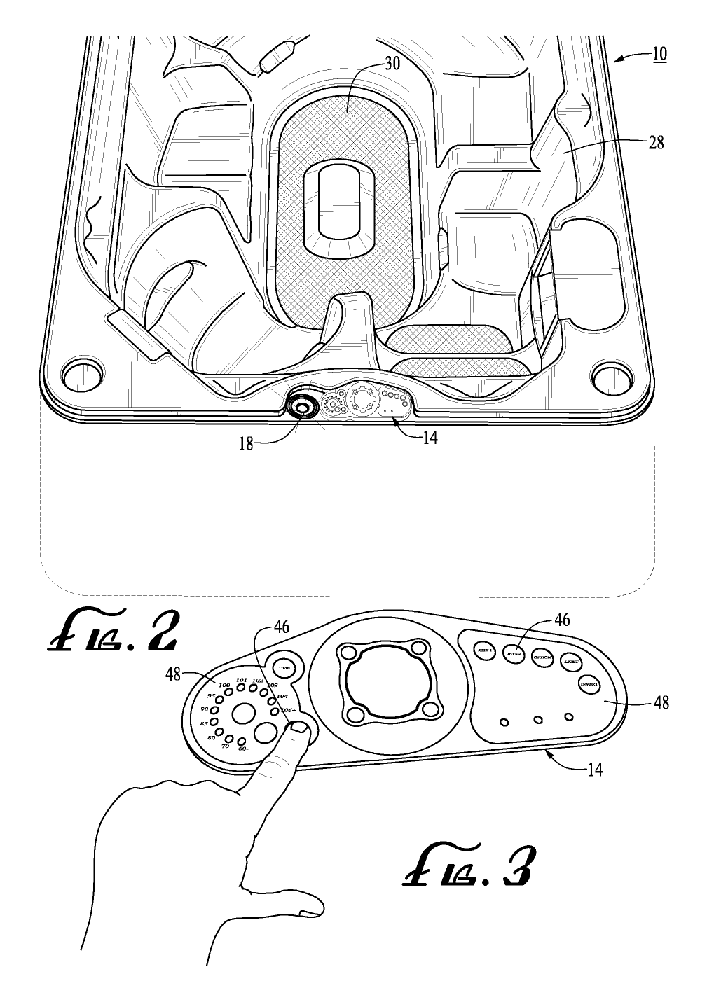

As illustrated in FIG. 3, the control panel 14 comprises a plurality of control buttons 46 operatively adapted such that the engagement of a control button 46 controls the operation of at least the water pump 24 or the water heater 26. Typically, the control buttons 46 on the panel 14 are covered with a water impervious film 48 disposed in contact with the control buttons 46.

The control buttons 46 are typically the momentary contact buttons, that is, control buttons 46 which continue to function while being depressed. For example, such a momentary contact button adapted to increase the pump speed would continue to increase the pump speed (up to some maximum) throughout the time while the button was depressed.

The audio circuit 16 comprises an audio system control module 52 and the speaker 18 and is operatively adapted to emit an audible signal through the speaker 18 in response to the engagement of a control button 46. For example, the engagement of a momentary contact-type control button 46 adapted to increase the speed of the water pump 24 will cause an audible signal to be emitted from the speaker 18 which increases in intensity or pitch while the speed of the water pump 24 is caused to increase. Similarly, the audio circuit 16 can be adapted to cause an audible signal to be emitted from the speaker 18 which decreases in intensity or pitch when the speed of the water pump 24 is caused to decrease.

The audio circuit 16 can further be adapted to cause an audible signal emitted from the speaker 18 to increase in intensity or pitch when the temperature of the heater 26 is caused to increase, and be adapted to emit an audible signal from the speaker 18 which decreases in intensity or pitch when the temperature of the heater 26 is caused to decrease.

Preferably, the audible signal emitted from each control button 46 is unique so that bathers can immediately recognize which control button 46 has been engaged by the emitted signal associated with that control button 46.

FIG. 4 illustrates how the audio circuit 16 can be operatively adapted with the control panel 14 and a conventional control box 54. In the embodiment illustrated in FIG. 4, the control box 54 comprises an auxiliary control panel 56.

The invention solves the problem associated with the difficulty in perceiving the engagement of a control button 46 because it is disposed beneath the water impervious film 48. Using the invention, the engagement of a control button 46 causes the emission of an audio signal which corresponds to the increase or decrease of the parameter which is controlled by that control button 46.

Moreover, the invention solves the problem of such control panels 14 being difficult to see in bright light, such as in sunlight. Using the invention, the engagement of control buttons 46 on the control panel 14 causes the emission of appropriate audible signals, thereby negating the need to accurately see the display on the control panel 14 in bright light conditions.

Still further, the invention solves the problems posed by bathers within the apparatus wishing to adjust selected control settings on control panels 14 which are disposed distant from the water basin 20 and/or facing away from the interior of the water basin 20. Using the invention, bathers within the water basin 20 can merely reach over the top of the control panel 14, engage a control button 46 and listen to the emitted audible signal to confirm that the correct control button 46 is engaged.

Finally, the invention satisfies the problem posed by blind bathers. Using the invention, blind bathers can quickly and easily adjust the various control settings using only the audible signals emitted by the engagement of the various control buttons 46.

Having thus described the invention, it should be apparent that numerous structural modifications and adaptations may be resorted to without departing from the scope and fair meaning of the instant invention as set forth hereinabove and as described hereinbelow by the claims.

What is claimed is:

1. A water recreational apparatus comprising:
(a) a water recirculation system having a water pump and a water heater;
(b) a control panel having a plurality of control buttons, the control buttons being operatively adapted such that the engagement of a control button controls the operation of the water pump or the water heater; and
(c) an audio circuit having a speaker and being operatively adapted to emit an audible signal in response to the engagement of a control button.

2. The water recreational apparatus of claim 1 wherein the control buttons on the control panel are covered with a single, continuous water impervious film, the water impervious film being disposed in contact with the control buttons.

3. The water recreational apparatus wherein the control buttons are momentary contact buttons.

4. The water recreational apparatus of claim 1 wherein the audible signal increases in intensity or pitch when the speed of the water pump is caused to increase.

5. The water recreational apparatus of claim 1 wherein the audible signal decreases in intensity or pitch when the speed of the water pump is caused to decrease.

6. The water recreational apparatus of claim 1 wherein the audible signal increases in intensity or pitch when the temperature of the heater is caused to increase.

7. The water recreational apparatus of claim 1 wherein the audible signal decreases in intensity or pitch when the temperature of the heater is caused to decrease.

8. The water recreational apparatus of claim 1 wherein the audio circuit is adapted to emit a unique audible signal in response to the engagement of each of a plurality of control buttons on the control panel.
